(19) United States
(12) Patent Application Publication
(10) Pub. No.: US 2010/0025951 A1
(43) Pub. Date: Feb. 4, 2010

(54) STEERING KNUCKLE FOR A MOTOR VEHICLE

(75) Inventors: Oliver Buchwald, Birenbach (DE); Matthias Dzioba, Leonberg (DE); Tycho Eulenstein, Kassel (DE); Rudolf Reinhardt, Esslingen (DE); Heiko Steinmetz, Ohmden (DE); Peter Tattermusch, Esslingen (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 11/993,242

(22) PCT Filed: Jun. 20, 2006
(86) PCT No.: PCT/EP06/05884

§ 371 Date: Apr. 16, 2008

(30) Foreign Application Priority Data
Jun. 25, 2005 (DE) 10 2005 029 539.8

(51) Int. Cl. B62D 7/18; B23K 11/00

(52) U.S. Cl. 280/93.512; 219/117.1

(57) ABSTRACT

The invention relates to an axle journal (1) which is connected to a vehicle body and which comprises an approximately rotation-symmetrical bearing journal (3) which can be connected to a wheel (5) of the vehicle. The invention also relates to a method for producing an axle journal (1). According to the invention, the axle journal is embodied in a divided manner, comprising an axle journal base body (7) and bearing journals (3), which penetrate a corresponding opening (9) in the axle journal base body (7), in order to meet the requirements of the high component stresses and to produce the axle journal (1) in an economical manner. The bearing journals (3) comprise a journal part (11) and a counter part (13), which are connected together inside the opening (9) by means of a press welding method.

The invention relates to a steering knuckle or axle journal according to the preamble of claim 1 and to a method of manufacturing an axle journal according to claim 12.

In a motor vehicle the axle journal carries the wheel and is connected to the vehicle body. In the case of a steered wheel it is attached to the vehicle body by way of a steering arm, and the axle journal is capable of pivoting about the steering axis. The axle journal furthermore comprises a bearing journal, to which the wheel is rotatably secured by means of bearings. Due to the high wheel contact forces, a high mechanical stress loading of the bearing journal occurs on the axle journal at the transition to the bearing contact shoulder, so that the component has to be produced from a high-grade material or needs to be subjected to localized changes in the grain structure in order to improve the stress load bearing capacity.

Known axle journals of this type are produced as integrally formed components, which are manufactured from a steel material by a forging process, for example. These have disadvantages in terms of production engineering, however, since the forging of such a complex component carries high tooling and production costs.

The object of the invention is to propose an axle journal and a method of manufacturing this, which is capable of withstanding the high stress loads occurring in operation and which is cost-effective to produce.

According to the invention the object is achieved by the features of claims 1 and 12.

According to the invention the axle journal is of divided design construction comprising an axle journal body and the bearing journal, which passes through a corresponding cylindrical aperture in the axle journal body, the bearing journal comprising a journal part and a counterpart, which are joined together inside the aperture by a press welding method. The complex axle journal component is thus comprised of two individual components, each of which has a simpler geometry and can be separately produced and machined prior to assembly. The overall component is therefore easier and more cost effective to manufacture.

A friction welding process is advantageously chosen as press welding method. This is particularly well suited to the joining of rotationally symmetrical components, as in this case (claim 2).

In an advantageous embodiment the aperture in the axle journal body has a widening on the side facing the journal part in order to receive the weld bead. In this way the spread of the weld bead produced in the friction welding can be purposely confined and the weld bead can additionally be used for mechanically clamping the axle journal body to the axle journal (claim 3).

The journal part advantageously has a press fit in relation to the aperture in the axle journal body. The operating stress loads introduced into the axle journal can thus be better absorbed and distributed over the length of the aperture (claim 4).

The axle journal body is advantageously composed of a cast material or is alternatively produced as a forging from an aluminum wrought alloy. The bearing journal is furthermore advantageously composed of a steel material. A weight saving can therefore be achieved, compared to an integrally formed axle journal, by manufacturing the body from a light material, which need not be weldable, whilst the heavily stressed journal is composed of a high-grade material suitable for additional measures designed to increase the strength locally in the areas particularly subject to stress (claims 5 to 7).

In one embodiment the counterpart has an assembly recess on its end face remote from the aperture. This represents a simple means of allowing the geometry of the axle journal to be optimally matched to the overall space available (claim 8).

At least one projection, which in the friction welding forms a positive interlock with the softened material of the journal part and/or the counterpart, is advantageously provided inside the aperture. This affords an additional means of mechanically clamping the individual components together and gives the axle journal great strength (claim 9).

The journal part advantageously has a shoulder with which it bears against a bearing contact face on the axle journal body adjacent to the aperture. This measure also serves to enhance the mechanical clamping of the components (claim 10).

The counterpart and/or the journal part advantageously have, at least in parts, a truncated cone-shaped geometry with a diameter diminishing towards the joining area. This serves to further increase the mechanical clamping that occurs after joining the parts (claim 11).

The invention further relates to a method of manufacturing an axle journal from an axle journal body having an approximately rotationally symmetrical aperture, and a bearing journal. The bearing journal comprises a journal part and a counterpart. The journal part is first inserted into the aperture from one side. The counterpart is then introduced into the aperture from the other side and with its end face is brought at least into partial contact with the end face of the bearing journal. In the final step of the method, the counterpart and the bearing part are permanently joined together inside the aperture by a press welding method (claim 12).

In an advantageous embodiment the counterpart is made to rotate during the friction welding and displaced in the direction of its longitudinal axis, whilst the journal part remains fixed inside the aperture. This firstly affords a simple way of performing the method, since only one component having a simple geometry needs to be set in rotation. Secondly, the journal part can already be pressed into the opening prior to the friction welding (claim 14).

The friction welding can furthermore be undertaken by first softening the face areas of the counterpart and the journal part through rotation and then displacing the counterpart and/or the journal part in the direction of its longitudinal axis without any rotational movement, until it bears with an end bearing shoulder against a bearing contact face on the wheel carrier body. This permits a precise joining of the journal part and the counterpart with a high stress load bearing capacity of the joining area (claim 15).

Further embodiments and advantages of the invention are set forth in the other dependent claims and the description.

In the drawings the invention is explained in more detail by reference to several exemplary embodiments.

In the drawings:

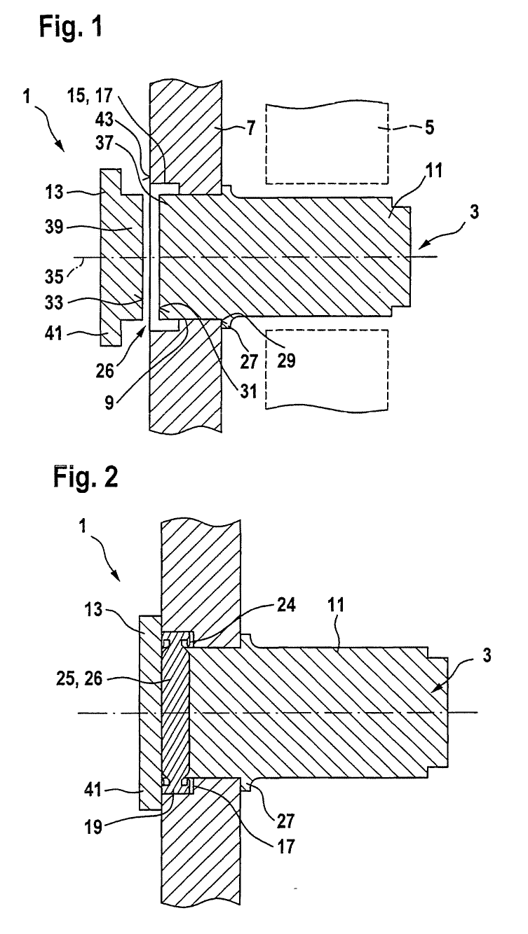

FIG. 1 shows a schematic drawing of the axle journal prior to assembly and the subsequent friction welding,

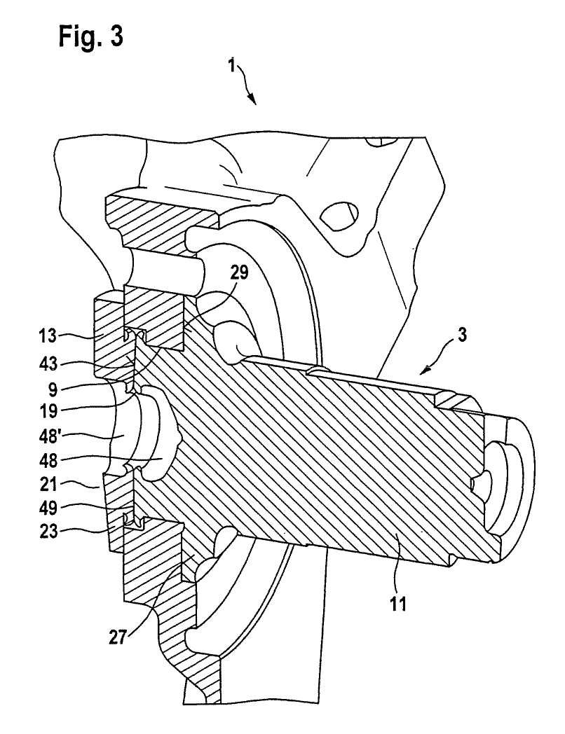

FIG. 2 shows a schematic drawing of the axle journal after the friction welding,

FIG. 3 shows a sectional representation of the finished axle journal,

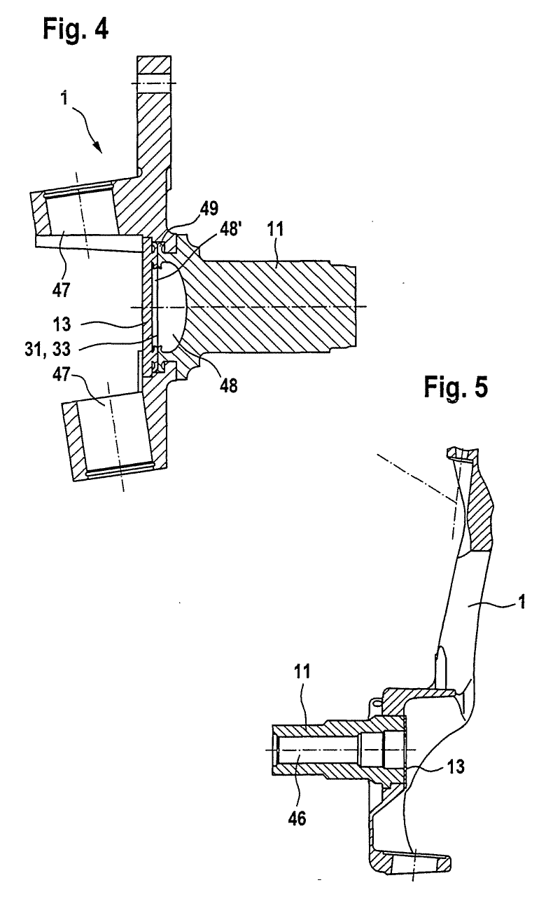

FIG. 4 shows an axle journal on a rigid axle of a motor vehicle,

FIG. 5 shows an axle journal on an independent wheel suspension of a motor vehicle,

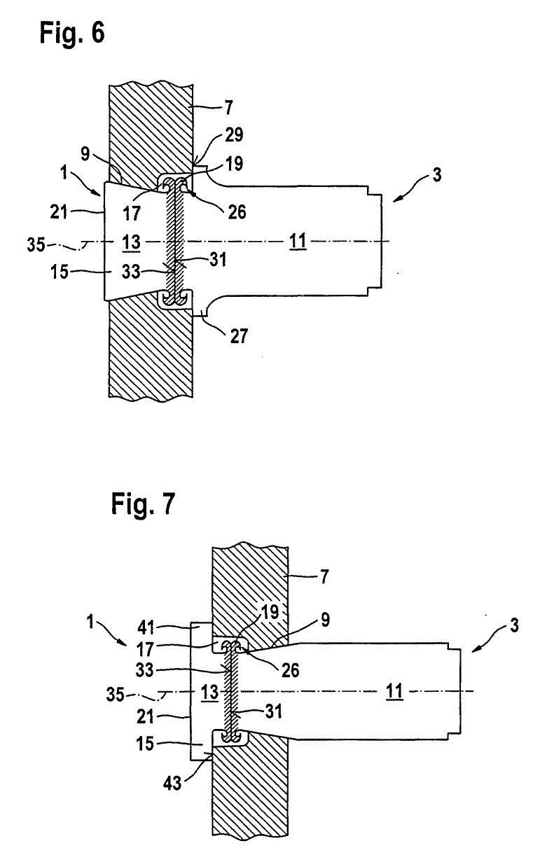

FIG. 6 shows an exemplary embodiment of the axle journal with journal part of truncated cone shape,

FIG. 7 shows an exemplary embodiment of the axle journal with counterpart of truncated cone shape and

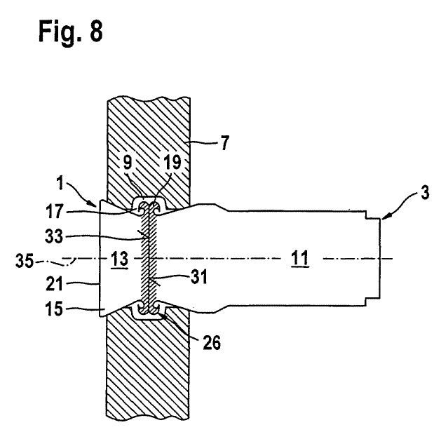

FIG. 8 shows an exemplary embodiment of the axle journal with counterpart and journal part of truncated cone shape.

FIG. 1 shows a schematic representation of an axle journal 1 according to the invention.

An axle journal 1 in a motor vehicle carries a wheel 5 of the vehicle, here merely indicated, rotatably supporting it on a bearing journal 3. The axle journal 1 is furthermore connected to the vehicle body. FIG. 1 shows the divided axle journal 1 in a state prior to assembly. The axle journal 1 in this state comprises three individual components: firstly the axle journal body 7, which is connected to the vehicle body and has an approximately rotationally symmetrical aperture 9. In the assembled state the bearing journal 3 is situated in this aperture 9. On a side 15 remote from the wheel 5 the aperture 9 in the axle journal body 7 has a widening 17, the function of which is yet to be described.

The bearing journal 3 is in turn made up of two components: a rotationally symmetrical journal part 11, which represents the actual wheel mounting, and a counterpart 13. Before assembly of the axle journal 1, both components 11, 13 have two corresponding end faces 31 and 33. In this embodiment the journal part 11 furthermore comprises an annular shoulder 27 arranged on the circumferential face. The counterpart 13 also comprises an annular shoulder 41, so that the diameter of the counterpart 13 on the side remote from the wheel 5 exceeds the diameter of the aperture 9.

The three components: axle journal body 7, journal part 11 and counterpart 13 may be composed of different materials:

In this exemplary embodiment the axle journal body 7 is manufactured from a cast material, such as grey cast iron or spheroidal-graphite cast iron (GJS) or an aluminum material, although it can also be made in any way from a steel material. The axle journal body 7 may furthermore be manufactured as a forging from an aluminum wrought alloy.

The bearing journal 3 is preferably composed of a steel material, which must be suitable for a friction welding process. A heat-treated steel or a case-hardened steel material is feasible, for example.

The two parts of the bearing journal 3 here may equally well be composed of two different materials: the journal part 11 is made from a heat-treated steel, which meets the great demands placed on the journal area in operation. A material which, at the points particularly subject to stress, has already been subjected to an additional treatment, such as local induction hardening, for example, is advantageous here. The counterpart on the other hand may be composed of readily weldable steel material. A typically advantageous combination of materials for the bearing journal 3, for example, is a journal part 11 of 42CrMo4 and a counterpart 13 of St52.

The method of manufacturing the axle journal 1 now involves the following steps, for example:

The journal part 11 is first inserted into the aperture 9 from one side, where it is fixed. This fixing can be achieved by a press fit between the aperture 9 and the journal part 11. Alternatively, the journal part 11 can be pushed into the aperture 9 until the shoulder 27 comes into contact with an associated bearing contact face 29 on the axle journal body 7.

In this exemplary embodiment the axle journal body 7 and the journal part 11 are then rotationally locked.

From the other side the counterpart 13 is now introduced into the aperture 9, until with its end face 33 it comes into contact with the end face 31 of the journal part 11. A friction welding process is now performed by setting the counterpart 13 in rotation whilst simultaneously applying pressure in the direction of its longitudinal axis 35. The material in the opposing face areas 39, 37 of the counterpart 13 and the journal part 11 is thereby softened, and the two components 11, 13 start to be joined together.

For performing the friction welding in a friction welding machine, mounts are provided in the rotating counterpart 13, for example, by means of which it can be clamped into the friction welding machine.

Once the material in the face areas 37, 39 of the journal part 11 and the counterpart 13 has been sufficiently softened by the rotation and the pressure, and it is in a pasty state, the rotational movement is stopped and a purely upsetting translational movement is performed in the direction of the longitudinal axis 35 of the counterpart 13. This movement ceases at the point when the shoulder 41 of the counterpart 13 comes into contact with an associated bearing contact face 43 on the axle journal body 7. The components 11, 13 are therefore upset in the joining area 26 until a defined limit is reached.

FIG. 2 shows the finished axle journal 1 on completion of the friction welding process. Cooling causes the materials 25 of the journal part 11 and the counterpart 13, softened by the friction welding, to contract in the joining area 26. This material shrinkage causes the material of the axle journal body 7 defining the aperture 9 to be clamped by the two shoulders 27 and 41 enclosing it. This gives the complete axle journal 1 the desired high strength. The weld seam shrinkage is therefore deliberately used for tensioning the axle journal 1.

In order to reduce any unwanted hardening in the welding zone, induction tempering of the weld zone can be performed via the counterpart 13. Alternatively, the complete axle journal can be subjected to furnace annealing.

It can further be seen from FIG. 2 how the weld bead 19 produced in the friction welding is received in the widening 17. A projection 24, which in this exemplary embodiment is additionally provided in the widening 17, contributes to the mechanical clamping of the components 7, 11, 13 through the positive interlock with the softened material 25 in the joining area 26, and serves to secure the connection against rotation.

Besides the individual projection 24 represented in FIG. 2, multiple projections may also be provided, which further enhance the clamping effect. It is also feasible to provide a profile, such as a knurled profile, produced by a series of projections.

FIG. 3 shows a detailed side view of a further exemplary embodiment of the axle journal 1 produced by friction welding. This example differs primarily by virtue of the special configuration of the aperture 9 and the bearing contact faces 29 and 43 adjoining this, together with the design of the shoulder 27 of the journal part.

In this exemplary embodiment the friction welded connection between the journal part 11 and the counterpart 13 is not extensive but is limited to an annular edge area 49 of the end faces 31 and 33 produced by corresponding recesses 48, 48′.

This embodiment further provides for an angular orientation in the friction welding. In this case the counterpart 13 is held in a defined angular position following the rotational movement. In this way it is possible to purposely position an assembly recess 23 or the like on the end face 21 of the counterpart 13 remote from the aperture 9, it then being possible to use said recess as an assembly aid for adjacent components.

The use of the divided axle journal 1 on a rigid axle is represented as a further exemplary embodiment in FIG. 4. This may be a rigid axle of a truck, for example. The axle journal 1 is here connected to the vehicle body by axle bolts (not shown here) seated in the eyes 47.

FIG. 5 by contrast shows a divided axle journal 1 on a steered axle of an individual wheel suspension. Here the axle journal 1 is attached to the vehicle body by steering arms (not shown) and is supported so that it can pivot about a steering axis 45. The wheel 5 (not shown here) situated on the axle journal 1 is moreover driven by a drive shaft 46 led through the bearing journal 3 embodied as a hollow shaft.

FIG. 6 shows a further embodiment of the axle journal 1. Identical parts are provided with the same reference numerals. In contrast to the examples represented above, the counterpart 13 here has a truncated cone-shaped geometry. The diameter of the counterpart 13 in this case diminishes towards the joining area 26. The aperture 9 in the axle journal body 7 is at the same time matched to the geometry of the counterpart 13. Here the weld bead 19 is accommodated by a widening 17, which is arranged on the side of the aperture 9 remote from the counterpart 13. As in FIGS. 1 and 2, the journal part 11 has a shoulder 27, which following the welding process bears against a corresponding bearing contact face 29. In this way a very strong mechanical clamping can be obtained between the components 11, 13 and the axle journal body 7. The shoulder 41 on the counterpart 13 can be dispensed with.

FIG. 7 shows a similar embodiment. Here the journal part 11 has a truncated cone-shaped geometry. The widening 17 for the weld bead 19 again lies on the side 15 of the aperture 9 which is remote from the journal part 11, the aperture accordingly also having a truncated cone-shaped area. Thus the shoulder 27 on the journal part 11 can be dispensed with whilst maintaining an equally strong clamping of the connection.

FIG. 8 shows a combination of the two examples. Here both the journal part 11 and the counterpart 13 have truncated cone-shaped areas, the cross sections of which each taper towards the joining area 26. The widening 17 is shifted into the center of the aperture and the shoulders 27, 41 on the journal part 11 and the counterpart 13 can be dispensed with.

This concept of a divided axle journal 1 joined by friction welding can therefore be equally well applied both to steered wheels and non-steered wheels and to both driven and non-driven wheels of an independent wheel suspension, or to a rigid axle on trucks and passenger vehicles. The concept can furthermore be used both for rear axle concepts and for front axles.

Because the axle journal 1 can be designed as a composite component with individual components 7, 11, 13 composed of various materials, it first of all affords weight advantages. The material of the axle journal body 7 can be optimized from a lightweight construction standpoint, since it does not need to fulfill any joining requirements. With this composite concept no direct connection is required between the material of the axle journal body 7 and that of the bearing journal 3.

Since they have a far simpler geometry than the axle journal 1 embodied as an integrally formed component, the individual components 7, 11, 13 can furthermore be optimized with regard to their production. For example, the bearing journal 3 can be produced from simple bar stock.

Furthermore, the concept also affords advantages in terms of overall space, since the individual components 7, 11, 13 can be designed separately with regard to the overall space needed.

The materials of the individual components 7, 11, 13 can be specifically matched to the component requirements. Thus, for example, a cast material which is less sensitive to thermal stresses, may be selected for the axle journal body 7, whilst the bearing journal 3 can be produced from a weldable and heat-treatable material.

In this respect, designing the axle journal 1 as a composite component represents an optimum in terms of stress loading and cost.

The axle journal 1 and the method of manufacturing it are not limited to the exemplary embodiments shown.

Firstly, the way in which journal part 11 bears against the axle journal body 7 can also be designed differently. It is feasible, for example, to provide a fit between the two components 7, 11 or a shoulder 27 on the journal 11 having a design shape other than an annular one.

In general terms, the configuration of the joining area may differ from the geometries shown in the exemplary embodiments.

In contrast to the conduct of the method described above, it is also possible in the friction welding to fix the counterpart 13 and to have the journal part 11 rotate. The counterpart 13 could then be pressed into the aperture 9 first and the journal part welded on in the next step.

Besides the friction welding processes represented in the exemplary embodiments, the components can also be joined by some other suitable press welding method, for example by a resistance press welding method or an ultrasonic welding method.

1. An axle journal (1), which is joined to a vehicle body and comprises an approximately rotationally symmetrical bearing journal (3), to which a wheel (5) of the vehicle can be connected, wherein the axle journal (1) is of divided design construction comprising an axle journal body (7) and the bearing journal (3), which passes through a corresponding aperture (9) in the axle journal body (7), the bearing journal (3) comprising a journal part (11) and a counterpart (13), which are joined together inside the aperture (9) by a press welding method.

2. The axle journal as claimed in claim 1, wherein a friction welding process is used as press welding method.

3. The axle journal as claimed in claim 2, wherein the aperture (9) in the axle journal body (11) has a widening (17) on the side (15) remote from the journal part (11) in order to receive the weld bead (19).

4. The axle journal as claimed in claim 1, wherein the journal part (11) has a press fit in relation to the aperture (9) in the axle journal body (7).

5. The axle journal as claimed in claim 1, wherein the axle journal body (7) is composed of a cast material.

6. The axle journal as claimed in claim 1, wherein t the axle journal body (7) is produced as a forging from an aluminum wrought alloy.

7. The axle journal as claimed in claim 2, wherein the bearing journal (3) is composed of a steel material.

8. The axle journal as claimed in claim 2, wherein the counterpart (13) has an assembly recess (23) on its end face (21) remote from the aperture (9).

9. The axle journal as claimed in claim 2, wherein at least one projection (24), which in the friction welding forms a positive interlock with the softened material (25) of the journal part (11) and/or the counterpart (13), is provided inside the aperture (9).

10. The axle journal as claimed in claim 2, wherein the journal part (11) has a shoulder (27) with which it bears against a bearing contact face (29) on the axle journal body (7) adjacent to the aperture (9).

11. The axle journal as claimed in claim 1, wherein the counterpart (13) and/or the journal part (11) have, at least in parts, a truncated cone-shaped geometry with a diameter diminishing towards the joining area (26).

12. A method of manufacturing an axle journal (1) from an axle journal body (7) having an approximately rotationally symmetrical aperture (9), and a bearing journal (3), which comprises a journal part (11) and a counterpart (13), said method comprising the following steps:
inserting the journal part (11) into the aperture (9) from one side,
introducing the counterpart (13) into the aperture (9) from the other side and with its end face (33) is brought at least into partial contact with the end face (31) of the bearing journal (3), and
permanently joining together the counterpart (13) and the bearing part (11) inside the aperture (9) by a press welding method.

13. The method as claimed in claim 12, wherein a friction welding process is used as press welding method.

14. The method as claimed in claim 13, wherein the counterpart (13) is made to rotate during the friction welding and displaced in the direction of its longitudinal axis (35), whilst the journal part (11) remains fixed inside the aperture (9).

15. The method as claimed in claim 13, wherein the friction welding is undertaken by first softening the face areas (37, 39) of the journal part (11) and the counterpart (13) through rotation and then displacing at least one of the counterpart (13) and the journal part (11) in the direction of its longitudinal axis (35) without any rotational movement, until it bears with an end bearing shoulder (41) or (27) against a bearing contact face (43) or (29) on the axle journal body (7) body.

16. The method as claimed in claim 13, wherein the journal part (11) or the counterpart (13) is pressed into the aperture (9) prior to the friction welding.
